(19) United States
(12) Patent Application Publication
(10) Pub. No.: US 2023/0196090 A1
(43) Pub. Date: Jun. 22, 2023

(54) INTELLIGENT CHARGING OF MULTIPLE VEHICLES THROUGH LEARNED EXPERIENCE

(71) Applicant: Rivian IP Holdings, LLC, Plymouth, MI (US)

(72) Inventors: John Michael Joseph Chaykowsky, Los Angeles, CA (US); William D. Vreeland, Palo Alto, CA (US)

(21) Appl. No.: 17/557,539

(22) Filed: Dec. 21, 2021

(51) Int. Cl. G06N 3/08; B60L 58/12; B60L 53/62; B60L 53/66; B60L 53/64

(52) U.S. Cl. CPC G06N 3/08; B60L 58/12; B60L 53/62; B60L 53/66; B60L 53/64

(57) ABSTRACT

Systems and methods for vehicle charging are disclosed. The system is configured to aggregate available data associated with states of multiple vehicles and a charging site and associated with charging the multiple vehicles at the charging site. The system is also configured to inference a pre-trained learning model to apply a charging policy to the available data to charge the vehicles at the charging site. The pre-trained learning model includes one or more learning agents configured to take actions and to observe effects of the actions in a simulated charging environment to obtain the charging policy.

### INTRODUCTION

The present disclosure relates generally to the automotive and vehicle charging fields. More particularly, the present disclosure relates to the intelligent charging of multiple vehicles through learned experience.

Electric vehicles can arrive at a charging site at various times, at various states of charge, and with varying departure times. Each of the electric vehicles needs to be charged with an appropriate amount of charge by the respective departure time, which can be difficult to optimize.

The present introduction is provided as illustrative environmental context only and should not be construed as being limiting in any manner. It will be readily apparent to those of ordinary skill in the art that the concepts and principles of the present disclosure may be applied in other environmental contexts equally.

### SUMMARY

The present disclosure provides a vehicle charging system and methods that utilize a learning model, such as a Policy Gradient Algorithm, to manage a charging policy for charging multiple vehicles at a charging site which is a multi-vehicle charging site. Whereby real-world data may be difficult to obtain in great quantities, a learning model utilizes simulation modeling which can represent near-real situations and edge cases that may not be apparent in the data. Scenarios of the simulation modeling can be run en masse and be used to learn an effective strategy to charge multiple vehicles, such as a vehicle fleet. The optimal strategy can be effectively modeled using neural networks with a Policy Gradient Algorithm, such as a reinforcement learning algorithm including a PPO-clip.

In one illustrative embodiment, the present disclosure provides a vehicle charging system. The vehicle charging system includes one or more processors and a memory storing computer-executable instructions that, when executed, cause the one or more processors to: aggregate available data associated with states of multiple vehicles and a charging site and associated with charging the multiple vehicles at the charging site; and inference a pre-trained learning model to apply a charging policy to the available data to charge the multiple vehicles at the charging site, the pre-trained learning model including one or more learning agents configured to take actions and to observe effects of the actions in a simulated charging environment to obtain the charging policy.

In another illustrative embodiment, the present disclosure provides a method for vehicle charging. The method includes aggregating available data associated with states of multiple vehicles and a charging site and associated with charging the multiple vehicles at the charging site. The method also includes inferencing a pre-trained learning model to apply a charging policy to the available data to charge the multiple vehicles at the charging site. The pre-trained learning model including one or more learning agents configured to take actions and to observe effects of the actions in a simulated charging environment to obtain the charging policy.

In a further illustrative embodiment, the present disclosure provides a method for vehicle charging. The method includes training a learning model to obtain a charging policy using one or more learning agents configured to take actions and to observe effects of the actions in a simulated charging environment using at least one set of data chosen from simulated data and a cache of data collected for charging multiple vehicles at one or more charging sites. The method also includes aggregating available data associated with states of multiple vehicles and a charging site and associated with charging the multiple vehicles at the charging site. The method further includes inferencing the learning model to apply the charging policy to the available data to charge the vehicles at the charging site.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic illustration of one illustrative embodiment of a charging system of the present disclosure;

FIG. 2 is a schematic illustration of one illustrative embodiment of a charging site of the present disclosure;

FIG. 3 is a schematic illustration of one illustrative embodiment of a charging model for the simulated environment of the present disclosure;

FIG. 4 is a schematic illustration of one illustrative embodiment of failure modeling of the present disclosure;

FIG. 5 is a flowchart of one illustrative embodiment of a method for modeling vehicle charging of the present disclosure;

FIG. 6 is a network diagram of a cloud system for implementing the various systems and methods of the present disclosure;

FIG. 7 is a block diagram of a server/processing system that may be used in the cloud system of FIG. 6 or stand-alone; and

FIG. 8 is a block diagram of a charging control system that may be used in the cloud system of FIG. 6 or stand-alone.

### DETAILED DESCRIPTION

Again, in various embodiments, the present disclosure relates to a vehicle charging system and methods that utilize a learning model, such as a Policy Gradient Algorithm, to manage a charging policy for charging multiple vehicles, such as a fleet of vehicles, at a charging site (multi-vehicle charging site). The learning model utilizes a simulation environment that models the charging infrastructure and the vehicles therein. The charging infrastructure is modeled to account for Alternating Current (AC)stations, Direct Current (DC) power cabinets in a daisy-chain configuration, power source costs and emissions, and the like. The vehicles are modeled to account for arrival and departure times, a state and condition of the battery, and the like. By modeling the simulation environment in this way and utilizing a learning model, a charging policy can be optimized and can be updated regularly to address any changes at the charging site without much, if any, input from a user and without a need to accurately predict future states of the charging site infrastructure and the vehicles.

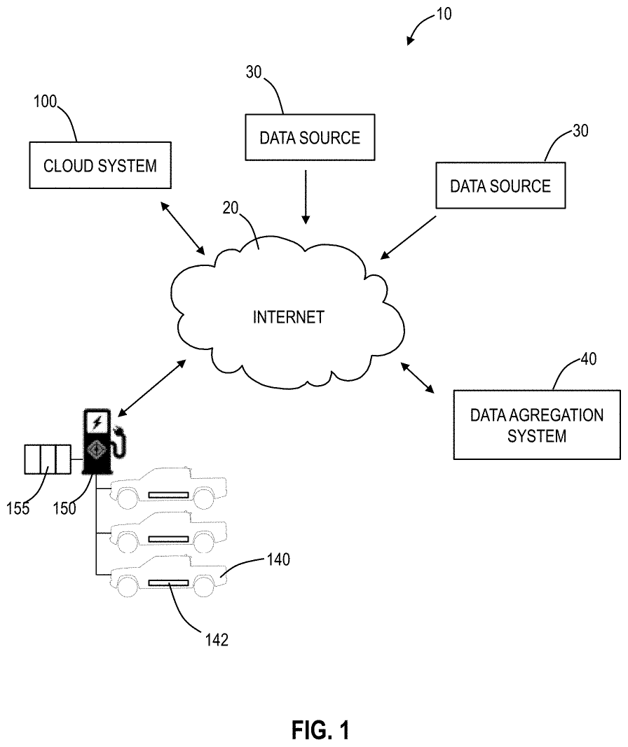

FIG. 1 is a schematic illustration of one illustrative embodiment of a charging system 10 of the present disclosure. In various embodiments, the charging system 10 includes a cloud system 100 and a charging site 150. At least one system chosen from the cloud system 100 and the charging site 150 is configured to utilize a reinforcement learning model which models the infrastructure of the charging site 150 and the vehicles with a simulation environment and a charging policy is learned using an on-policy reinforcement algorithm to optimize charging of multiple vehicles 140 at the charging site 150. Thus, in embodiments, the learning model is inferenced by one of the cloud system 100, the charging site 150, or a combination of the cloud system 100 and the charging site 150. Other configurations for applying or inferencing the learning model are also contemplated. In various embodiments and as will be discussed in further detail below, the learning model is pre-trained in a simulation environment to obtain a charging policy and then inferenced to apply the charging policy to charge multiple vehicles at a charging site 150.

In various embodiments, the charging is optimized by modeling the simulation environment and aggregating available data associated with the charging the vehicles 140 at the charging site 150. In various embodiments, the available data includes at least one data type associated with states of the vehicles 140/charging site 150 (such as data which can be used to describe a state of the vehicles 140/charging site 150) chosen from an arrival time of each vehicle 140, a state of charge of a battery 142 of each vehicle 140, a charge curve for the battery 142 of each vehicle 140, details of the battery 142 of each vehicle (such as nominal capacity, usable capacity, temperature, and the like), departure time of the vehicle 140, a minimum required charge of each vehicle 140, power source structures (for Alternating Current (AC) stations and/or Direct Current (DC) cabinets), and power source data, such as energy rates and/or carbon emissions data (carbon emissions produced/a score for carbon emissions produced during production of the power supplied for charging vehicles 140 at the charging site 150). In embodiments, the power source data is obtained from one or more data sources 30, the charging site 150 (particularly when the charging site 150 is equipped with one or more renewable energy sources 155, such as solar panels, wind turbines, solar cells, energy storage devices, and the like, that are adapted to provide power for charging the vehicles 140). In various embodiments, the energy storage devices are any of portable rechargeable battery packs, backup power systems, electrochemical batteries, gravity batteries, and the like.

In some embodiments, a data aggregation system 40 provides at least some of the power source data, such as any of the energy rates and/or carbon emissions data. For example, in embodiments, the data aggregation system 40 is configured to obtain the carbon emissions data associated with the utility grid location(s) associated with the charging site 150 and provide carbon emissions data including one or more of real-time carbon emissions data, historical carbon emissions data, and carbon forecasted emissions data. In these embodiments, the cloud system 100 or the charging site 150 obtains the carbon emissions data from the data aggregation system 40. In other embodiments, the cloud system 100 or the charging site 150 is configured to obtain the carbon emissions data associated with the utility grid locations from the data sources 30 and determine emissions data for each charging site 150 including one or more of real-time emissions data, historical emissions data, and forecasted emissions data for the charging site 150. In embodiments, the emissions data is any of an amount of carbon emitted, a scaled score, such as a scale from clean emissions to dirty emissions, and the like. In some embodiments, the data sources 30 are the utility grid locations, an electricity provider, and the like.

In some embodiments, the power source data includes data from the one or more renewable energy sources 155, such as power produced thereby, a percentage of power provided thereby to the charging site 150, and the like.

As will be discussed in greater detail below, in various embodiments, the simulation environment is modeled to use at least one set of data chosen from simulated data and a cache of data collected from one or more charging sites, which includes at least one data type chosen from the data types disclosed above.

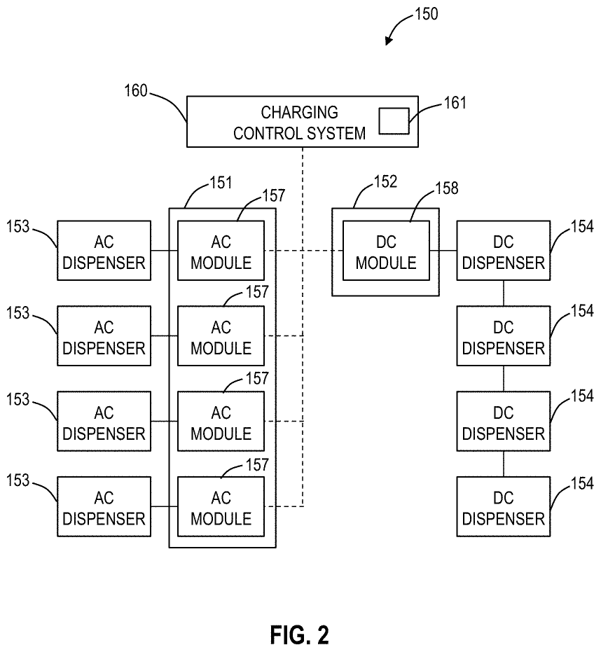

FIG. 2 is a schematic illustration of one illustrative embodiment of a charging site 150 of the present disclosure. In embodiments, the charging site 150 includes a charging control system 160 and one or more power sources 151, 152. In embodiments, the charging control system 160 is configured to inference the learning model to apply the charging policy to charge the vehicles 140 at the charging site 150, such as via an optimization application 161. In some embodiments, the optimization application 161 is a stand-alone application, while in other embodiments, the optimization application 161 integrates with the cloud system 100 to inference the learning model.

In embodiments, the power sources 151, 152 include AC power stations 151, DC power cabinets 152, or a combination of AC power stations 151 and DC power cabinets 152. In the embodiment illustrated, the charging site 150 includes one AC power station 151 and one DC power cabinet 152. In embodiments, the AC power station 151 includes one or more AC modules 157, each adapted to provide power to a corresponding AC dispenser 153, such as a stall configured to receive a vehicle 140. The DC power cabinet 152 includes one or more DC modules 158, each adapted to provide power to one or more DC dispensers 154, such as stalls configured to receive a vehicle 140. As illustrated in FIG. 2, in embodiments, the DC dispensers 154 are arranged in a daisy-chain architecture, where the DC module 158 provides power to the associated DC dispensers 154 one at a time for any given time period to charge the vehicles 140 at each of the DC dispensers 154. As only one vehicle 140 can be charged for any given time period in a daisy chain architecture, various sequences can be used to charge the vehicles 140, such as fully charging each of the vehicles 140 sequentially, charging each of the vehicles 140 sequentially to a minimum required charge before charging each of the vehicles 140 to a full charge, intermittently charging vehicles 140 by rotating charging thereof based on one or more time periods, and the like.

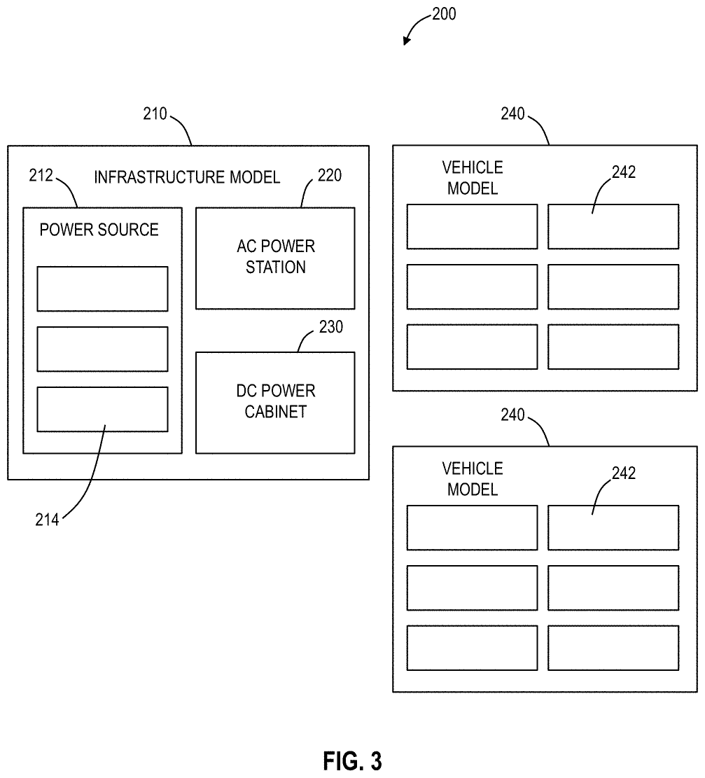

FIG. 3 is a schematic illustration of one illustrative embodiment of a charging model 200 for the simulated environment of the present disclosure. In embodiments, the charging model 200 includes a charging infrastructure model 210 of a charging site 150 and vehicle models 240 that model vehicles 140 to be charged thereby. In embodiments, one or more learning agents of a learning model are rewarded for any of charging vehicles on-time, at a low cost, and with a low release of carbon emissions associated therewith.

In various embodiments, the charging infrastructure model 210 includes a model 212 of the power source(s) that provide power for charging the vehicles 140, which includes any combination of one or more objects 214 associated with the power source(s). In embodiments, the model 212 includes at least one object 214 chosen from an object modeling energy rates, an object modeling carbon emissions, and an object modeling renewable energy sources 155.

In embodiments, the charging infrastructure model 210 includes an AC power station model 220 that models AC power stations 151 of a charging site 150 and a DC power cabinet model 230 that models the DC power cabinets 152 of the charging site 150. In embodiments, the AC power station model 220 is abstracted from reality where, instead of having an individual AC module for each dispenser, the AC power station model 230 defines a single object that includes a set of output channels and a set of dispensers where a number of the output channels is equal to a number of dispensers.

In embodiments, the DC power cabinet model 220 is modeled as a set of n output channels with m dispensers per output channel to characterize the daisy-chain architecture. As disclosed above, in a daisy-chain architecture, only one vehicle can be charged at a time for any given time period.

In various embodiments, the charging infrastructure model 210 makes assumptions with regards to a charging efficiency and power loss for the AC power station model 220 and the DC power cabinet model 230. In embodiments, these assumptions are predetermined, such as based on an average efficiency and power loss of the AC power station 151 and DC power cabinets 152, provided by a user, determined from data obtained from a data source 30, and the like.

In embodiments, the vehicle model 240 includes any combination of one or more objects 242 associated with a state of the vehicle 140 chosen from an arrival time of the vehicle 140, a state of charge of the battery 142 of the vehicle 140, a charge curve for the battery 142 of the vehicle 140, details of the battery 142 of the vehicle (such as nominal capacity, usable capacity, temperature, and the like), a departure time of the vehicle 140, and a minimum required charge of the vehicle 140. In various embodiments, the data utilized for the charging model is chosen from one of simulated data, data associated with one or more charging sites 150 that is cached, and a combination thereof.

In various embodiments, the details of the battery 142, such as the usable capacity are assumed based on various factors, such as the model of the battery, the age of the battery, temperature of the battery, and the like. For example, in one embodiment, the AC charging efficiency is assumed (e.g. ninety percent) with no power loss and the DC charging efficiency is assumed (e.g. ninety-seven percent) with an assumed power loss (eg. six percent). Under the examplary assumptions, charging a vehicle 140 on AC at 10 kW for an hour would increase the battery energy by 9 kWh (90%*10 kW*1 hour); and charging a vehicle on DC at 100 kW for an hour (ignoring charging curve limitations) would increase battery energy by 97 kWh (97%*100 kW*1 hour). In embodiments, with DC charging, there are power conversion losses that occur at the DC power cabinet 152 that result in a difference between the power flowing into the DC power cabinet 152 and the power supplied to the vehicle 140 that is charging. This does not impact vehicle power draw, but it does impact the utility meter readings of power and energy. As a result, in the exemplary example, the vehicle 140 charging on DC at 100 kW for an hour, the meter readings would be 106 kWh energy supplied and 106 kW power demand. It should be understood that the values presented in this example are illustrative only and the actual values would be different based on various factors, such as the various factors discussed herein.

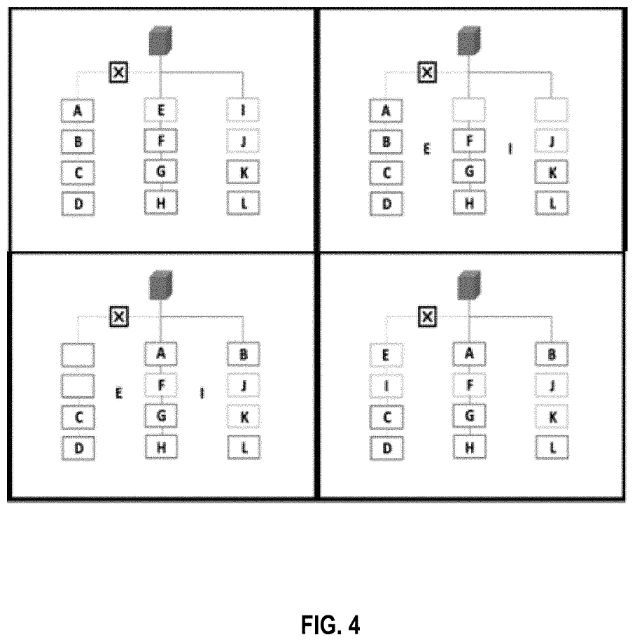

FIG. 4 is a schematic illustration of one illustrative embodiment of a daisy chain failure 300 of the present disclosure. Charging infrastructure can fail during a given charging cycle. In embodiments, the failure is modeled within the simulated environment by a predetermined span of times that a given DC dispenser 265 or set of DC dispensers 154 are down. The daisy chains must be reconfigured or the vehicles 140 re-routed within the working daisy chains in order to complete the charging of all of the vehicles. In some actual charging scenarios, movers at the charging site 150 will need to move/rearrange the vehicles 140 to accomplish the charging. As such, in some embodiments, a number of users is defined for the simulated model to address such failures. When inferencing the learning model, the data aggregated can include a number of movers, which can be user defined or can be based on data from a data source 30, such as employment software that identifies a number of workers currently clocked in for moving vehicles, and the like.

In the example illustrated in FIG. 4, the vehicles 140 are each represented by a letter, and each daisy chain 350 includes dispensers 354. Referring to pane 301, three vehicles 140 are charging and a daisy chain 350 breaks, resulting in only two vehicles to continue charging. In the example shown, vehicles 140 that have completed charging must be moved, such as by swapping them with the vehicles 140 that need re-routing. Referring to pane 302, the charged vehicles 140 are moved to make space for the re-routed vehicles 140. Referring to pane 303, the re-routed vehicles 140 begin charging again on the new daisy chains 350 and the charged vehicles remain in the deactivated dispensers 354 for a remainder of a dwell period. Referring to pane 304, the process begins again for the other two vehicles that need re-routing. In various embodiments, the re-routing of vehicles 140 is performed at different times and at different points in the daisy chains 350 depending on the optimization resulting from inferencing the learning model.

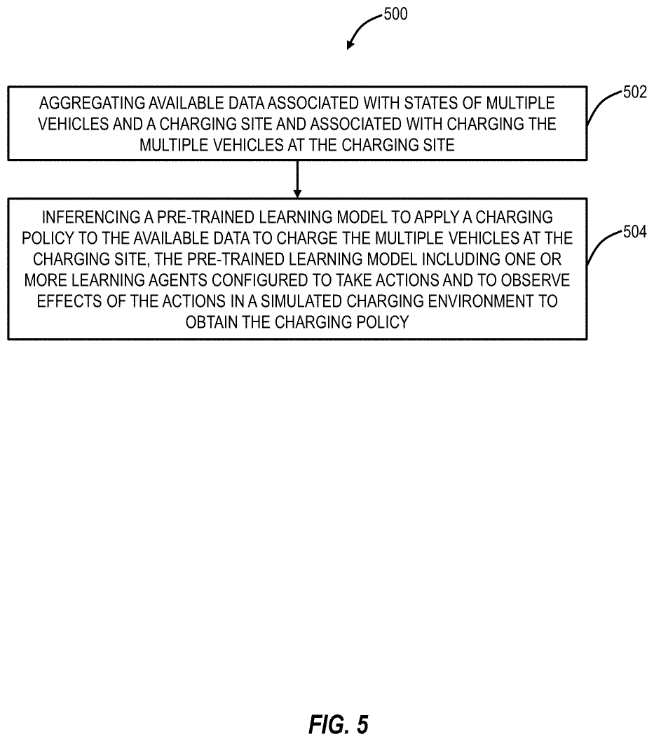

FIG. 5 is a flowchart of one illustrative embodiment of a method 500 for modeling vehicle charging of the present disclosure. The method includes aggregating available data associated with states of multiple vehicles and a charging site and associated with charging the multiple vehicles at the charging site at step 502. In embodiments, the one or more agents utilize an on-policy reinforcement learning algorithm to determine the charging policy. The method also includes inferencing a pre-trained learning model to apply a charging policy to the available data to charge the multiple vehicles at the charging site, the pre-trained learning model including one or more learning agents configured to take actions and to observe effects of the actions in a simulated charging environment to obtain the charging policy at step 504.

In some embodiments, the method further includes training the learning model to obtain the charging policy using the one or more learning agents configured to take actions and to observe effects of the actions in a simulated charging environment using at least one set of data chosen from simulated data and a cache of data collected for charging multiple vehicles at one or more charging sites. In some of these embodiments, the one or more learning agents update actions to be taken in the simulation environment based on expected rewards versus actual rewards, such as rewards based on minimizing a cost of electricity and minimizing carbon emissions output to produce the electricity.

In embodiments, the simulation environment includes any combination of the charging infrastructure models, vehicle models, and assumptions discussed herein.

In some embodiments, the simulated charging environment includes a charging infrastructure modeled to include at least one power source chosen from an Alternating Current (AC) station and a Direct Current (DC) power cabinet. In these embodiments, the at least one power source is modeled as a set of output channels and a set of dispensers, where each output channel supplies one or more dispensers of the set of dispensers. In some of these embodiments, each DC power cabinet of the at least one power source is modeled as a set of n output channels with m dispensers per output channel to characterize a daisy-chain architecture thereof. In some of these embodiments, each AC power station of the at least one power source is modeled as a single object that includes a set of output channels and a set of dispensers where a number of output channels is equal to a number of dispensers.

In some embodiments, the available data includes at least one data type chosen from energy rate data, carbon emissions data, and renewable energy source data, and wherein the simulated charging environment includes a charging infrastructure modeled to include at least one object chosen from an object modeling energy rates, an object modeling carbon emissions, and an object modeling renewable energy sources. In some embodiments, the simulated charging environment includes vehicles modeled to include at least one object chosen from an arrival time of a respective vehicle, a state of charge of a battery of the respective vehicle, a charge curve for the battery of the respective vehicle, details of the battery of the respective vehicle, a departure time of the respective vehicle, and a minimum required charge of the respective vehicle.

In some embodiments, the charging infrastructure is modeled to include failure of a charging dispenser by including a predetermined span of time that a given dispenser is down.

In some embodiments, the learning model is inferenced to update a charging scheme at the charging site based on a detected change to the infrastructure and the vehicles to be charged. In various embodiments, the detected change includes at least one change chosen from a change in a number of vehicles to be charged, a change in departure time of one of the vehicles to be charged, a failure at a power source, a failure at a dispenser, and installation of additional dispensers. In embodiments, the charging policy is updated on a predetermined interval.

In some embodiments of the method, the pre-trained learning model includes a Policy Gradient Algorithm (PGA), such as Reinforcement learning, Actor-Critic, Asynchronous Advantage Actor-Critic, Advantage Actor-Critic, Deterministic policy gradient, combinations thereof, and the like. In some of these embodiments, the PGA is configured to train a neural network based on at least one set of data chosen from simulated data and a cache of data collected from one or more charging sites.

In various embodiments, the PGA is configured to train a neural network that includes a set of parameters θ that define the charging policy. In embodiments, the neural network is inferenced by providing an observation of a given state to obtain an action that will receive a reward. In embodiments, the observation of a given state is user defined.

Trajectories, or samples, are drawn from the simulation environment (or cached from real life charging data) by one or more learning agents taking actions and observing the effects of such actions in the simulation environment. In embodiments, a set of n trajectories is a mini-batch and is used to perform an update on the set of parameters, given a reward function. In some embodiments, the reward function is also user defined. In embodiments, The PGA uses rewards determined from the reward function to update the set of parameters by utilizing an optimizer, such as a stochastic gradient descent (SGD), and an objective function.

In embodiments, the objective function is configured to model a loss function L(s,a,θₖ,θ), such as a log π_{θ} (aₖ|sₖ) Aₖ, where Aₖ consists of the difference between a discounted sum of rewards and expected rewards V_{ϕ} (sₜ). In embodiments, the expected rewards V_{ϕ} (sₜ) is modeled as a neural network, or any predictive model, with parameters ϕ and is configured to predict the rewards of an action given a state. In embodiments, the PGA is configured to update the parameters ϕ by evaluating the predictions of the expected rewards against the actual rewards using an evaluation metric, such as mean-squared error (MSE). In embodiments, the advantage function, Aₖ, is configured to update the parameters of the policy model θ, as shown above in the objective function, by encouraging actions taken by the one or more learning agents that obtain positive advantage and discouraging actions taken by the one or more learning agents that provide negative advantages. In some of these embodiments, the overall update is then clipped, such as via a Proximal Policy Optimization (PPO), to discourage drastic changes.

In some embodiments, the PPO supports parallelization using multi-processing, which allows for discrete and continuous action spaces to be tested under a single umbrella method. In some of these embodiments, a Clipped Surrogate Objective is used. In one exemplary embodiment, a PPO-clip updates policies via,

$${θ}_{k + 1} = arg \begin{matrix}max \\ θ\end{matrix} \begin{matrix}E \\ s , a \sim {π}_{{θ}_{k}}\end{matrix} [ L ( s , a , {θ}_{k} , θ ) ]$$

where θ represents the set of parameters of the learned policy network, E is an expectation function, L is a loss function, [symbol] is a policy. In embodiments, SGD maximizes the objective via the traditional method given a minibatch size and learning rate (lr), where θ=θ−lr*grad(obj). In various embodiments, the log probabilities of the policy network times the difference of the discounted sum of rewards and the value function provides an approximation of rewards.

In embodiments, the discounted sum of rewards=Σₖ₌₀^{T}γ^{k}rₜ+k, where γ is the discount factor. In various embodiments, the discount factor is user defined. In some embodiments, the discount factor is set to 0.99.

In some embodiments, the PGA includes:

```
1. Input initial policy parameters θ₀ and initial value function parameters
  ϕ₀.
2. For k = 0, 1, 2, . . . do:
3. Collect a set of trajectories Dₖ = {τᵢ} by running policy πₖ = π(θₖ) in
  the environment.
4. Compute rewards-to-go \hat{R}ₜ.
5. Compute advantage estimates, Âₜ based on the rewards and the current
  value function V_{ϕ}_{ₖ}.
6. Update the policy by maximizing the PPO-clip objective:
${θ}_{k + 1} = arg \begin{matrix}max \\ θ\end{matrix} \frac{1}{\vert {D}_{k} \vert T} {\sum }_{τ ∈ {D}_{k}} {\sum }_{t = 0}^{T} min ( \frac{{π}_{θ} ( {a}_{t} \vert {s}_{t} )}{{π}_{{θ}_{k}} ( {a}_{t} \vert {s}_{t} )} {A}^{{π}_{{θ}_{k}}} ( {S}_{t} , {a}_{t} ) , g ( ϵ , {A}^{{π}_{{θ}_{k}}} )$
7. Fit the value function by regression on mean-squared error:
${θ}_{k + 1} = arg \begin{matrix}min \\ θ\end{matrix} \frac{1}{\vert {D}_{k} \vert T} {\sum }_{τ ∈ {D}_{k}} {\sum }_{t = 0}^{T} {( {V}_{ϕ} ( {s}_{t} ) - {\hat{R}}_{t} )}^{2}$
8. End for.
```

In various embodiments, Reward function \hat{R}ₜ is manually defined prior to training and the value function is modeled using another neural network that is a predictive model.

In embodiments, the method, and any of the embodiments outlined above, is performed by a system chosen from one of a cloud system 100, a charging control system 160 of a charging site 150, and a combination of the cloud system 100 and the charging control system 160.

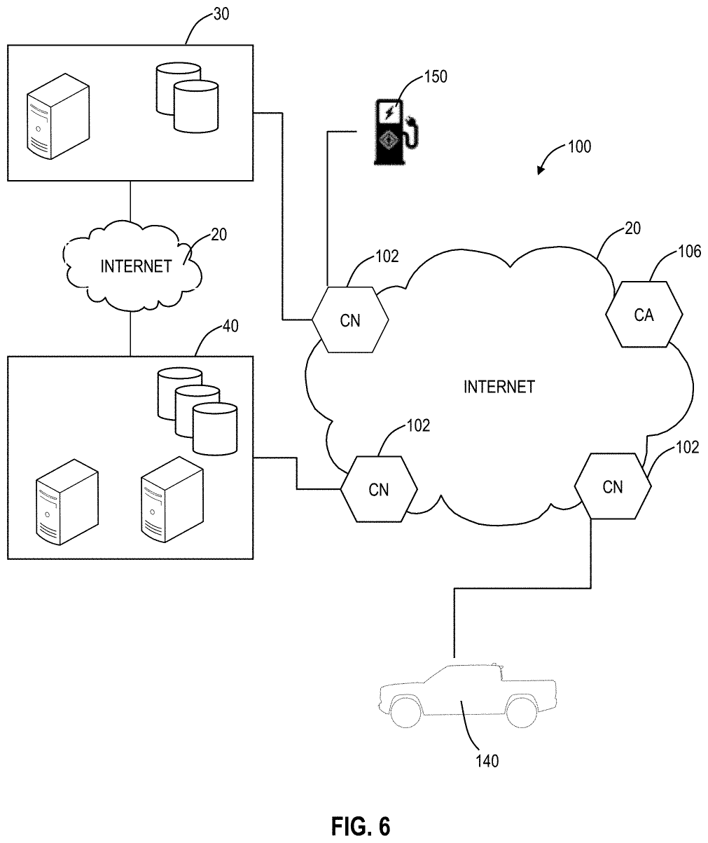

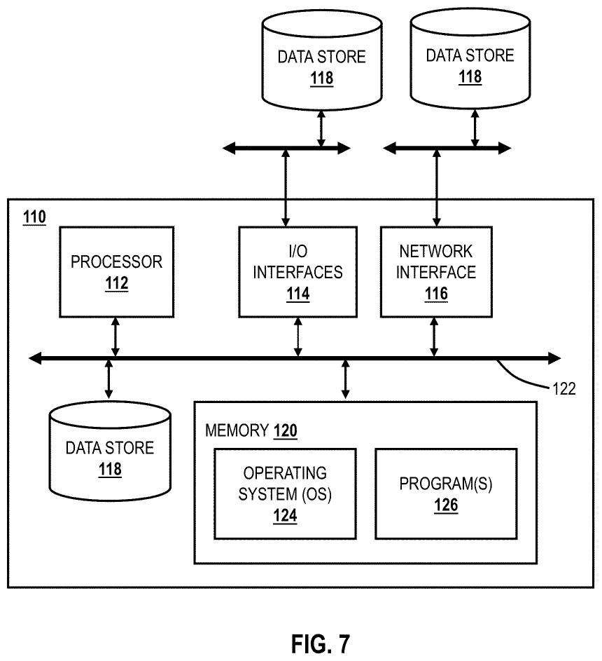

FIG. 6 is a network diagram of a cloud system 100 for implementing the various systems and methods of the present disclosure. In embodiments, the cloud system 100 is a cloud-based system that includes one or more cloud nodes (CNs) 102 communicatively coupled to the Internet 104 or the like. In embodiments, the cloud nodes 102 are implemented as a server or other processing system 110 (as illustrated in FIG. 7) or the like and are geographically diverse from one another, such as located at various data centers around the country or globe. Further, in some embodiments, the cloud system 100 includes one or more central authority (CA) nodes 106, which similarly are implemented as the server 110 and are connected to the CNs 102. For illustration purposes, the cloud system 100 connects to data sources 30, a data aggregation system 40, charging sites 150, and vehicles 140, each of which communicatively couples to one of the CNs 102. These locations 30, 40, and 150, and vehicles 140 are shown for illustrative purposes, and those skilled in the art will recognize there are various access scenarios to the cloud system 100, all of which are contemplated herein. The cloud system 100 can be a private cloud, a public cloud, a combination of a private cloud and a public cloud (hybrid cloud), or the like.

Again, the cloud system 100 provides any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the charging sites 150, and the vehicles 140.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” is sometimes used to describe application programs offered through cloud computing. A common shorthand for a provided cloud computing service (or even an aggregation of all existing cloud services) is “the cloud.” The cloud system 100 is illustrated herein as one example embodiment of a cloud-based system, and those of ordinary skill in the art will recognize the systems and methods described herein are not necessarily limited thereby.

FIG. 7 is a block diagram of a server or other processing system 110, which may be used in the cloud system 100 (FIG. 6), in other systems, or stand-alone. For example, the CNs 102 (FIG. 6) and the central authority nodes 106 (FIG. 6) may be formed as one or more of the servers 110. In embodiments, the server 110 is a digital computer that, in terms of hardware architecture, generally includes a processor 112, input/output (I/O) interfaces 114, a network interface 116, a data store 118, and memory 120. It should be appreciated by those of ordinary skill in the art that FIG. 7 depicts the server or other processing system 110 in an oversimplified manner, and a practical embodiment may include additional components and suitably configured processing logic to support known or conventional operating features that are not described in detail herein. The components (112, 114, 116, 118, and 120) are communicatively coupled via a local interface 122. The local interface 122 may be, for example, but is not limited to, one or more buses or other wired or wireless connections, as is known in the art. The local interface 122 may have additional elements, which are omitted for simplicity, such as controllers, buffers (caches), drivers, repeaters, and receivers, among many others, to enable communications. Further, the local interface 122 may include address, control, and/or data connections to enable appropriate communications among the aforementioned components.

The processor 112 is a hardware device for executing software instructions. The processor 112 may be any custom made or commercially available processor, a central processing unit (CPU), an auxiliary processor among several processors associated with the server 110, a semiconductor-based microprocessor (in the form of a microchip or chipset), or generally any device for executing software instructions. When the server 110 is in operation, the processor 112 is configured to execute software stored within the memory 120, to communicate data to and from the memory 120, and to generally control operations of the server 110 pursuant to the software instructions. The I/O interfaces 114 may be used to receive user input from and/or for providing system output to one or more devices or components.

The network interface 116 may be used to enable the server 110 to communicate on a network, such as the Internet 114 (FIG. 6). The network interface 116 may include, for example, an Ethernet card or adapter (e.g., 10 BaseT, Fast Ethernet, Gigabit Ethernet, or 10 GbE) or a Wireless Local Area Network (WLAN) card or adapter (e.g., 802.11a/b/g/n/ac). The network interface 116 may include address, control, and/or data connections to enable appropriate communications on the network. A data store 118 may be used to store data. The data store 118 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 118 may incorporate electronic, magnetic, optical, and/or other types of storage media. In one example, the data store 118 may be located internal to the server 110, such as, for example, an internal hard drive connected to the local interface 122 in the server 110. Additionally, in another embodiment, the data store 118 may be located external to the server 110 such as, for example, an external hard drive connected to the I/O interfaces 114 (e.g., a SCSI or USB connection). In a further embodiment, the data store 118 may be connected to the server 110 through a network, such as, for example, a network-attached file server.

In embodiments, the memory 120 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 120 may incorporate electronic, magnetic, optical, and/or other types of storage media. Note that the memory 120 may have a distributed architecture, where various components are situated remotely from one another but can be accessed by the processor 112. The software in memory 120 may include one or more software programs, each of which includes an ordered listing of executable instructions for implementing logical functions. The software in the memory 120 includes a suitable operating system (O/S) 124 and one or more programs 126. The operating system 124 essentially controls the execution of other computer programs, such as the one or more programs 126, and provides scheduling, input-output control, file and data management, memory management, and communication control and related services. The one or more programs 126 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

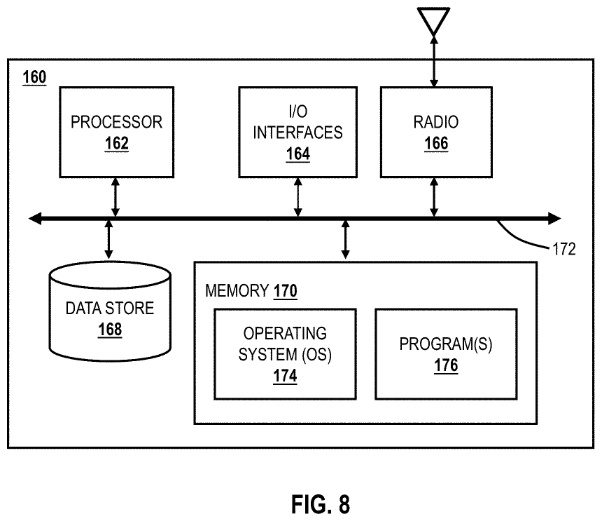

FIG. 8 is a block diagram of a charging control system 160 that may be used in the cloud system 100 of FIG. 6 or stand-alone. In embodiments, the charging control system 160 is a digital device that, in terms of hardware architecture, generally includes a processor 162, I/O interfaces 164, a radio 166, a data store 168, and memory 170. It should be appreciated by those of ordinary skill in the art that FIG. 8 depicts the charging control system 160 in an oversimplified manner, and a practical embodiment may include additional components and suitably configured processing logic to support known or conventional operating features that are not described in detail herein. The components (162, 164, 166, 168, and 170) are communicatively coupled via a local interface 172. The local interface 172 can be, for example, but is not limited to, one or more buses or other wired or wireless connections, as is known in the art. The local interface 172 can have additional elements, which are omitted for simplicity, such as controllers, buffers (caches), drivers, repeaters, and receivers, among many others, to enable communications. Further, the local interface 172 may include address, control, and/or data connections to enable appropriate communications among the aforementioned components.

The processor 162 is a hardware device for executing software instructions. In embodiments, the processor 162 is any custom made or commercially available processor, a CPU, an auxiliary processor among several processors associated with the charging control system 160, a semiconductor-based microprocessor (in the form of a microchip or chipset), or generally any device for executing software instructions. When the charging control system 160 is in operation, the processor 162 is configured to execute software stored within the memory 170, to communicate data to and from the memory 170, and to generally control operations of the charging control system 160 pursuant to the software instructions. In embodiments, the I/O interfaces 164 are used to receive user input from and/or for providing system output. User input can be provided via, for example, a user interface, a keypad, a scroll ball, a scroll bar, buttons, and the like. System output can be provided via a display device such as a liquid crystal display (LCD), touch screen, and the like.

The radio 166 enables wireless communication to an external access device or network. Any number of suitable wireless data communication protocols, techniques, or methodologies can be supported by the radio 166, including any protocols for wireless communication. The data store 168 may be used to store data. The data store 168 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, in embodiments, the memory 170 includes any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 170 may incorporate electronic, magnetic, optical, and/or other types of storage media. Note that the memory 170 may have a distributed architecture, where various components are situated remotely from one another, but can be accessed by the processor 162. The software in memory 170 can include one or more software programs, each of which includes an ordered listing of executable instructions for implementing logical functions. In the example of FIG. 8, the software in the memory 170 includes a suitable operating system 174 and programs 176. The operating system 174 essentially controls the execution of other computer programs and provides scheduling, input-output control, file and data management, memory management, and communication control and related services. The programs 176 may include various applications, add-ons, etc. configured to provide end user functionality with the charging control system 160. For example, example programs 176 may include, but not limited to, a web browser, charging control applications, the optimization application 161 (FIG. 2), and the like. In a typical example, the end-user typically uses one or more of the programs 176 along with a network, such as the cloud system 100 (FIG. 6).

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A vehicle charging system comprising:
one or more processors and a memory storing computer-executable instructions that, when executed, cause the one or more processors to:
aggregate available data associated with states of multiple vehicles and a charging site and associated with charging the multiple vehicles at the charging site; and
inference a pre-trained learning model to apply a charging policy to the available data to charge the multiple vehicles at the charging site, the pre-trained learning model including one or more learning agents configured to take actions and to observe effects of the actions in a simulated charging environment to obtain the charging policy.

2. The vehicle charging system of claim 1, comprising a system chosen from one of a cloud system, a charging control system of a charging site, and a combination of the cloud system and the charging control system.

3. The vehicle charging system of claim 1, wherein the simulated charging environment includes a charging infrastructure modeled to include at least one power source chosen from an Alternating Current (AC) station and a Direct Current (DC) power cabinet, and wherein the at least one power source is modeled as a set of output channels and a set of dispensers, where each output channel supplies one or more dispensers of the set of dispensers.

4. The vehicle charging system of claim 3, wherein each DC power cabinet of the at least one power source is modeled as a set of n output channels with m dispensers per output channel to characterize a daisy-chain architecture thereof.

5. The vehicle charging system of claim 1, wherein the available data includes at least one data type chosen from energy rate data, carbon emissions data, and renewable energy source data, and wherein the simulated charging environment includes a charging infrastructure modeled to include at least one object chosen from an object modeling energy rates, an object modeling carbon emissions, and an object modeling renewable energy sources.

6. The vehicle charging system of claim 1, wherein the simulated charging environment includes vehicles modeled to include at least one object chosen from an arrival time of a respective vehicle, a state of charge of a battery of the respective vehicle, a charge curve for the battery of the respective vehicle, details of the battery of the respective vehicle, a departure time of the respective vehicle, and a minimum required charge of the respective vehicle.

7. The vehicle charging system of claim 1, wherein the pre-trained learning model includes a Policy Gradient Algorithm (PGA) configured to train a neural network based on at least one set of data chosen from simulated data and a cache of data collected from one or more charging sites.

8. A method for vehicle charging comprising:
aggregating available data associated with states of multiple vehicles and a charging site and associated with charging the multiple vehicles at the charging site; and
inferencing a pre-trained learning model to apply a charging policy to the available data to charge the multiple vehicles at the charging site, the pre-trained learning model including one or more learning agents configured to take actions and to observe effects of the actions in a simulated charging environment to obtain the charging policy.

9. The method of claim 8, wherein the simulated charging environment includes a charging infrastructure modeled to include at least one power source chosen from an Alternating Current (AC) station and a Direct Current (DC) power cabinet, and wherein the at least one power source is modeled as a set of output channels and a set of dispensers, where each output channel supplies one or more dispensers of the set of dispensers.

10. The method of claim 9, wherein each DC power cabinet of the at least one power source is modeled as a set of n output channels with m dispensers per output channel to characterize a daisy-chain architecture thereof.

11. The method of claim 9, wherein each AC power station of the at least one power source is modeled as a single object that includes a set of output channels and a set of dispensers where a number of output channels is equal to a number of dispensers.

12. The method of claim 8, wherein the available data includes at least one data type chosen from energy rate data, carbon emissions data, and renewable energy source data, and wherein the simulated charging environment includes a charging infrastructure modeled to include at least one object chosen from an object modeling energy rates, an object modeling carbon emissions, and an object modeling renewable energy sources.

13. The method of claim 8, wherein the simulated charging environment includes vehicles modeled to include at least one object chosen from an arrival time of a respective vehicle, a state of charge of a battery of the respective vehicle, a charge curve for the battery of the respective vehicle, details of the battery of the respective vehicle, a departure time of the respective vehicle, and a minimum required charge of the respective vehicle.

14. The method of claim 8, wherein the pre-trained learning model includes a Policy Gradient Algorithm (PGA) configured to train a neural network based on at least one set of data chosen from simulated data and a cache of data collected from one or more charging sites.

15. A method for vehicle charging using reinforcement learning comprising:
training a learning model to obtain a charging policy using one or more learning agents configured to take actions and to observe effects of the actions in a simulated charging environment using at least one set of data chosen from simulated data and a cache of data collected for charging multiple vehicles at one or more charging sites;
aggregating available data associated with states of multiple vehicles and a charging site and associated with charging the multiple vehicles at the charging site; and
inferencing the learning model to apply the charging policy to the available data to charge the vehicles at the charging site.

16. The method of claim 15, wherein the learning model includes a Policy Gradient Algorithm (PGA), the PGA including a neural network that includes a set of parameters that define the charging policy, the set of parameters being updated based on trajectories obtained by the actions taken and the effects observed by the one or more learning agents given a reward function and an objective function.

17. The method of claim 15, wherein the learning model is configured to account for at least one consideration chosen energy costs and carbon emissions.

18. The method of claim 15, wherein the simulated charging environment includes a charging infrastructure modeled to include at least one power source chosen from an Alternating Current (AC) station and a Direct Current (DC) power cabinet, and wherein the at least one power source is modeled as a set of output channels and a set of dispensers, where each output channel supplies one or more dispensers of the set of dispensers.

19. The method of claim 18, wherein each DC power cabinet of the at least one power source is modeled as a set of n output channels with m dispensers per output channel to characterize a daisy-chain architecture thereof.

20. The method of claim 18, wherein each AC power station of the at least one power source is modeled as a single object that includes a set of output channels and a set of dispensers where a number of output channels is equal to a number of dispensers
